(19) United States
(12) Patent Application Publication
(10) Pub. No.: US 2025/0264685 A1
(43) Pub. Date: Aug. 21, 2025

(54) LENS DEVICE AND MANUFACTURING METHOD OF LENS DEVICE

(71) Applicant: FUJIFILM Corporation, Tokyo (JP)

(72) Inventors: Nobuyuki KONDO, Saitama-shi (JP); Kazuyoshi AZEGAMI, Saitama-shi (JP); Toshiaki EZAWA, Saitama-shi (JP)

(73) Assignee: FUJIFILM Corporation, Tokyo (JP)

(21) Appl. No.: 19/050,129

(22) Filed: Feb. 11, 2025

(30) Foreign Application Priority Data
Feb. 21, 2024 (JP) 2024-024508

(51) Int. Cl. G02B 7/02; G02B 27/64

(52) U.S. Cl. CPC G02B 7/023; G02B 7/022; G02B 27/646

(57) ABSTRACT

The lens device includes a fixation frame, a switch portion, and a fixing member that fixes the fixation frame and the switch portion to each other. The fixation frame includes a fitting portion and the fixing member includes a fitting target portion that is fitted to the fitting portion. The fitting target portion includes an elastic portion having elasticity and the fitting portion includes a contact portion that comes into contact with the elastic portion so that the elastic portion is elastically deformed.

### CROSS-REFERENCE TO RELATED APPLICATIONS

This application claims priority under 35 USC 119 from Japanese Patent Application No. 2024-024508 filed on Feb. 21, 2024, the disclosure of which is incorporated by reference herein.

### BACKGROUND OF THE INVENTION

### 1. Field of the Invention

The present disclosed technology relates to a lens device and a manufacturing method of a lens device.

### 2. Description of the Related Art

Disclosed in WO2020/100619A is a lens barrel including a frame that has an opening portion, a cover member that covers the opening portion, a fixation portion that is provided on an inner surface side of the cover member and is disposed inside the frame through the opening portion in a case where the opening portion is covered with the cover member, and a spring member that is engaged with the fixation portion and an inner wall surface portion of the frame and that biases the cover member in a direction in which the cover member is pulled into the inside of the frame.

Disclosed in JP2011-064970A is a rear-focus type lens device in which an internal structure including a focus lens is accommodated in an attachment frame, which is a rear portion of a lens barrel body. In the attachment frame, an internal wall portion that separates a first space, in which the internal structure is accommodated, and a second space, in which a switch assembly including a plurality of switches provided to operate the lens device is accommodated, from each other and an opening, which is an opening for the second space that is formed at a side surface of the attachment frame and through which a switch assembly is attached, are formed. The strength of the attachment frame is increased by the internal wall portion.

Disclosed in JP2014-098822A is a lens barrel including an operation ring that moves a moving lens group, a fixation ring that is fixed to the operation ring, a movement member that is disposed on the outer periphery of the fixation ring or a fixation member integrally attached to the fixation ring, a switch member in which the points of contact are switched therebetween in a case where the movement member is moved, and a click member that is engaged with the movement member and the switch member at a first engagement portion and a second engagement portion, respectively and that is engaged with a stepped portion at a third engagement portion, the stepped portion being provided at the fixation ring or the fixation member. The click member includes a fourth engagement portion that is engaged with the fixation ring or the fixation member in a direction orthogonal to a movement direction of the movement member.

Disclosed in JP2014-229527A is a switch mechanism that is mounted on a mounting target member and that is operated from the outside of the mounting target member. The switch mechanism includes an operation target portion that is operated from the outside of the mounting target member, a base portion that is positioned inside the mounting target member and that is moved in a case where the operation target portion is operated, a position defining member that is fixed to the base portion and that defines a position to which the base portion is moved, and a connecting portion that is fixed to the base portion and that operates a switching member positioned inside the mounting target member. The base portion and the connecting portion are formed of a non-conductor, and the position defining member is formed of metal having spring properties.

### SUMMARY OF THE INVENTION

The present disclosed technology provides a lens device and a manufacturing method of a lens device with which it is not necessary to use a screw to fix a switch portion to a fixation frame.

According to a first aspect of the present disclosed technology, there is provided a lens device including a fixation frame, a switch portion, and a fixing member that fixes the fixation frame and the switch portion to each other. The fixation frame includes a fitting portion, the fixing member includes a fitting target portion that is fitted to the fitting portion, the fitting target portion includes an elastic portion having elasticity, and the fitting portion includes a contact portion that comes into contact with the elastic portion to elastically deform the elastic portion.

According to a second aspect of the present disclosed technology, in the lens device according to the first aspect, the switch portion may include an outer member that is disposed to face an outside of the fixation frame, and an inner member that is disposed to face an inside of the fixation frame.

According to a third aspect of the present disclosed technology, in the lens device according to the second aspect, the fixation frame may include an opening, an outer shape portion of the outer member may be larger than the opening, and an outer shape portion of the inner member may be smaller than the opening.

According to a fourth aspect of the present disclosed technology, in the lens device according to the third aspect, the outer member may include an overlapping portion that overlaps a peripheral edge portion of the opening from the outside of the fixation frame.

According to a fifth aspect of the present disclosed technology, in the lens device according to the third or fourth aspect, the switch portion may be a switch unit that is unitized in a stage before insertion of the inner member into the opening.

According to a sixth aspect of the present disclosed technology, in the lens device according to any one of the first to fifth aspects, the switch portion may include a slide switch as a switch related to an operation performed on a lens, and a window portion that faces an inside of the fixation frame and that is open at a position corresponding to the slide switch.

According to a seventh aspect of the present disclosed technology, in the lens device according to the sixth aspect, the switch portion may include an inner member that is disposed to face the inside of the fixation frame, and the window portion may be formed at the inner member.

According to an eighth aspect of the present disclosed technology, in the lens device according to any one of the first to seventh aspects, a plurality of the fixing members may be provided, the plurality of fixing members may include a first fixing member that is disposed at a first end portion of the switch portion, and a second fixing member that is disposed at a second end portion of the switch portion.

According to a ninth aspect of the present disclosed technology, in the lens device according to any one of the first to eighth aspects, the switch portion may include a fixation portion, and the fixing member may include a fixing target portion that is fixed to the fixation portion.

According to a tenth aspect of the present disclosed technology, in the lens device according to the ninth aspect, the fixation portion may face an inside of the fixation frame.

According to an eleventh aspect of the present disclosed technology, in the lens device according to the tenth aspect, the fixation portion may include a first fixation portion formed at a first end portion of the fixation portion, and a second fixation portion formed at a second end portion of the fixation portion, and the fixing target portion may include a first fixing target portion that is fixed to the first fixation portion, and a second fixing target portion that is fixed to the second fixation portion.

According to a twelfth aspect of the present disclosed technology, in the lens device according to any one of the first to eleventh aspects, a fixing structure for fixation of the fixation frame and the switch portion may be a fitting structure.

According to a thirteenth aspect of the present disclosed technology, in the lens device according to any one of the first to twelfth aspects, the fitting portion may be formed at an inner peripheral surface of the fixation frame.

According to a fourteenth aspect of the present disclosed technology, in the lens device according to any one of the first to thirteenth aspects, the fitting portion may not be exposed at an outer peripheral surface of the fixation frame.

According to a fifteenth aspect of the present disclosed technology, in the lens device according to any one of the first to fourteenth aspects, a direction along a direction intersecting an optical axis may be set as a direction in which the fitting target portion is fitted to the fitting portion.

According to a sixteenth aspect of the present disclosed technology, in the lens device according to any one of the first to fifteenth aspects, the fitting portion may be formed in a recessed shape.

According to a seventeenth aspect of the present disclosed technology, in the lens device according to any one of the first to sixteenth aspects, the fitting portion may include a locking portion, and the fitting target portion may include a locking target portion that is engaged with the locking portion in a direction along an optical axis.

According to an eighteenth aspect of the present disclosed technology, in the lens device according to any one of the first to seventeenth aspects, the elastic portion may extend in a direction along a direction intersecting an optical axis.

According to a nineteenth aspect of the present disclosed technology, in the lens device according to any one of the first to eighteenth aspects, the fitting target portion may include a slit formed along the elastic portion.

According to a twentieth aspect of the present disclosed technology, in the lens device according to the nineteenth aspect, the switch portion may include a slide switch as a switch related to an operation performed on a lens, a direction along an optical axis may be set as a direction in which the slide switch is operated, and the slit may extend in a direction along a direction intersecting the optical axis.

According to a twenty-first aspect of the present disclosed technology, in the lens device according to any one of the first to twentieth aspects, the contact portion may have a shape that elastically deforms the elastic portion in a direction in which the switch portion is pulled toward an inside of the fixation frame.

According to a twenty-second aspect of the present disclosed technology, in the lens device according to any one of the first to twenty-first aspects, the contact portion may be formed in a protruding shape.

According to a twenty-third aspect of the present disclosed technology, in the lens device according to any one of the first to twenty-second aspects, the fitting target portion may include a plurality of hooked portions that are hooked onto the fitting portion, and the plurality of hooked portions may include a first hooked portion that is adjacent to the elastic portion on a first side in a direction along an optical axis, and a second hooked portion that is adjacent to the elastic portion on a second side in the direction along the optical axis.

According to a twenty-fourth aspect of the present disclosed technology, there is provided a manufacturing method of the lens device according to any one of the first to twenty-third aspects, the method including a fixing step of fixing a switch portion to a fixation frame by means of a fixing member. The fixing step includes a fitting step of fitting a fitting target portion of the fixing member to a fitting portion of the fixation frame, and the fitting step includes bringing an elastic portion of the fitting target portion into contact with a contact portion of the fitting portion so that the elastic portion is elastically deformed.

### BRIEF DESCRIPTION OF THE DRAWINGS

FIG. 1 is a side view of a lens device according to an embodiment of the present disclosed technology.

FIG. 2 is a side view of a state where a switch unit is fixed to a fixation frame.

FIG. 3 is a perspective view of the switch unit.

FIG. 4 is a trihedral view of the switch unit.

FIG. 5 is an exploded perspective view of the switch unit.

FIG. 6 is an exploded perspective view of the fixation frame, the switch unit, and a pair of fixing members.

FIG. 7 is an exploded perspective view of the fixation frame, the switch unit, and the pair of fixing members.

FIG. 8 is a perspective view of a state where the switch unit is fixed to the fixation frame.

FIG. 9 is an enlarged perspective view of part A shown in FIG. 8.

FIG. 10 is an enlarged perspective view of part A shown in FIG. 8 and is a view in which a fixing member is represented by imaginary lines.

FIG. 11 is an enlarged perspective view showing the fixation frame in part A shown in FIG. 8.

FIG. 12 is a perspective view of the fixing member.

FIG. 13 is an enlarged vertical cross-sectional view of a main part in a state where the switch unit is fixed to the fixation frame.

FIG. 14 is an enlarged perspective view of a main part in a state where the switch unit is fixed to the fixation frame.

FIG. 15 is an enlarged perspective view of a state where the switch unit is fixed to the fixation frame.

### DESCRIPTION OF THE PREFERRED EMBODIMENTS

Hereinafter, an embodiment of the present disclosed technology will be described.

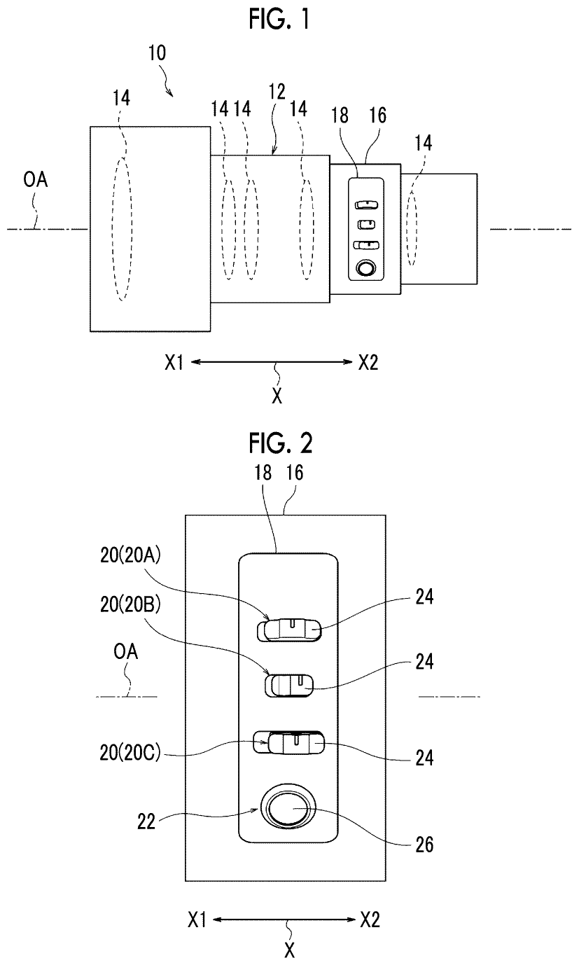

First, an overall configuration of a lens device 10 according to the present embodiment will be described. As shown in FIGS. 1 and 2, the lens device 10 includes a lens barrel 12 and a plurality of lenses 14. The lens device 10 is a lens device that can be applied to various cameras such as a digital still camera. The lens device 10 has an optical axis OA. A direction along an arrow X is a direction along the optical axis OA. An arrow X1 side is an object side in the direction along the optical axis OA and an arrow X2 side is an image formation side in the direction along the optical axis OA. In addition, the lens barrel 12 is formed in a tubular shape along a direction (hereinafter, will be referred to as a “direction around the optical axis”) around the optical axis OA, which is centered on the optical axis OA.

The plurality of lenses 14 are accommodated in the lens barrel 12. The plurality of lenses 14 are disposed to be arranged in the direction along the arrow X. The plurality of lenses 14 include an objective lens, a zoom lens, a focus lens, a camera shake correction lens, an imaging lens, and the like.

The lens barrel 12 includes a fixation frame 16. The fixation frame 16 is formed in an annular shape along the direction around the optical axis and is disposed such that the axis thereof coincides with the optical axis OA. The lens device 10 includes a switch unit 18. The switch unit 18 is an example of a “switch portion” according to the embodiment of the present disclosed technology. The switch unit 18 is provided at the fixation frame 16.

The switch unit 18 includes a plurality of switches related to an operation performed on at least one of the plurality of lenses 14. The switch unit 18 includes a plurality of slide switches 20 and a push-button switch 22 as examples of the plurality of switches. Hereinafter, in a case where it is necessary to distinguish the plurality of slide switches 20 from each other, the plurality of slide switches 20 will be referred to as slide switches 20A, 20B, and 20C. The slide switches 20A, 20B, and 20C and the push-button switch 22 are disposed to be arranged along the direction around the optical axis in order of the slide switches 20A, 20B, 20C, and the push-button switch 22. Note that the slide switches 20A, 20B, and 20C and the push-button switch 22 may be arranged in any order.

The lens device 10 has a function of switching an imaging distance range, a function of switching camera shake correction on or off, a function of selecting a focus position, and a function of setting a predetermined position as a focus position. The slide switch 20A is a switching switch provided to switch an imaging distance range, and the slide switch 20B is a switching switch provided to switch the camera shake correction on or off. The slide switch 20C is a switching switch provided to select a focus position, and the push-button switch 22 is a decision switch provided to set a predetermined position as a focus position.

Each slide switch 20 includes an operation portion 24 that is slidable. The direction along the arrow X is set as a direction in which each slide switch 20 is operated (that is, a direction in which the operation portion 24 is moved). The push-button switch 22 includes an operation portion 26 that can be pressed. A radial direction of the fixation frame 16 is set as a direction in which the push-button switch 22 is operated (that is, a direction in which the operation portion 26 is moved).

Note that although the switch unit 18 includes the plurality of slide switches 20 and the push-button switch 22, any of the plurality of slide switches 20 or the push-button switch 22 may be omitted. In addition, the switch unit 18 may include, as an example of the plurality of switches, a switch other than the above-described switches. In addition, the switch unit 18 may include a switch related to an operation performed on an element other than the lenses. Examples of the switch related to an operation performed on an element other than the lenses include a power switch.

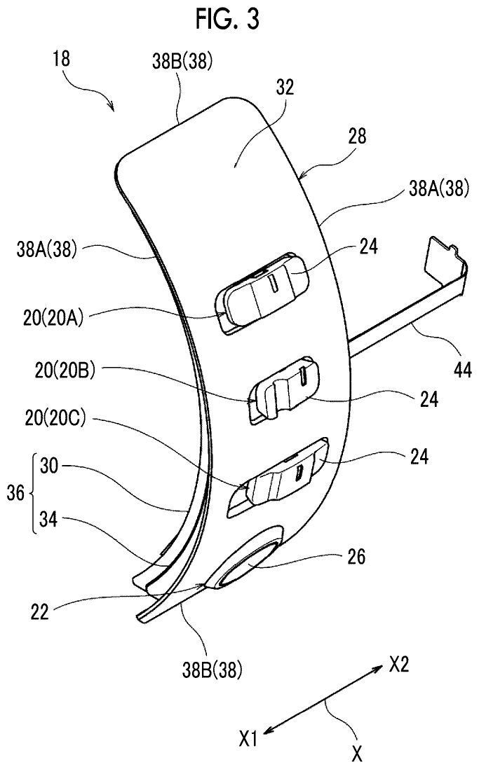

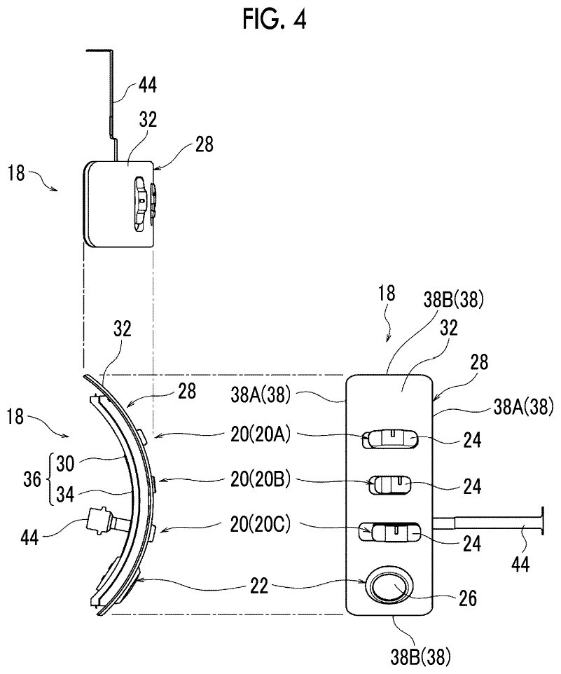

Subsequently, a configuration of the switch unit 18 will be described. As shown in FIGS. 3 and 4, the switch unit 18 is configured to be unitized in advance before the switch unit 18 is attached to the above-described fixation frame 16 (refer to FIGS. 1 and 2), and the switch unit 18 includes an outer case 28 and an inner case 30 in addition to the plurality of slide switches 20 and the push-button switch 22. The outer case 28 is an example of an “outer member” according to the embodiment of the present disclosed technology, and the inner case 30 is an example of an “inner member” according to the embodiment of the present disclosed technology. Each of the outer case 28 and the inner case 30 is formed in an arc shape. The outer case 28 constitutes an outer peripheral portion of the switch unit 18, and the inner case 30 constitutes an inner peripheral portion of the switch unit 18.

More specifically, the outer case 28 includes an exterior portion 32 and a case portion 34. The exterior portion 32 is formed in an arc-like plate shape, and the case portion 34 is provided on an inner peripheral side of the exterior portion 32. The operation portion 24 of each slide switch 20 is provided at the exterior portion 32 and can be operated from the outside of the switch unit 18. Similarly, the operation portion 26 of the push-button switch 22 is also provided at the exterior portion 32 and can be operated from the outside of the switch unit 18.

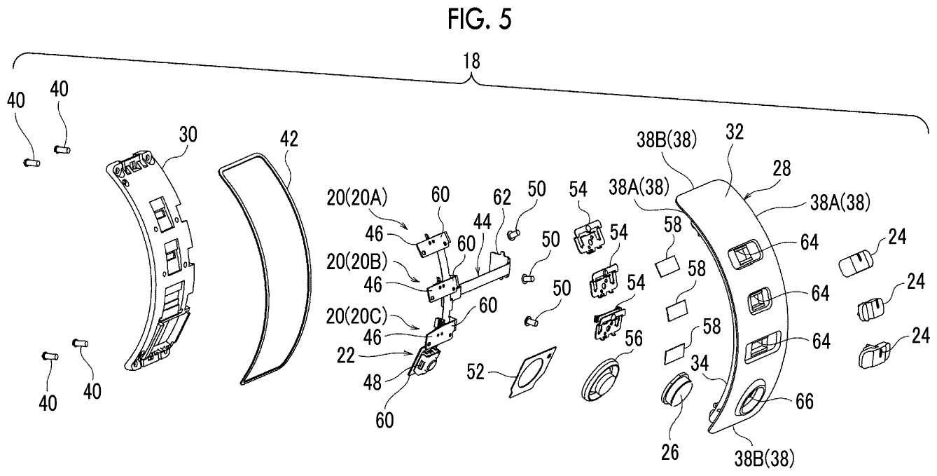

The inner case 30 is mounted to the case portion 34 on an inner peripheral side of the switch unit 18. The inner case 30 and the case portion 34 constitute an accommodation portion 36 that accommodates each of members (refer to FIG. 5) constituting the switch unit 18, which will be described later. The exterior portion 32 is formed in a longitudinal shape of which a lateral direction is the direction along the arrow X and a longitudinal direction is the direction along the optical axis. The exterior portion 32 is formed to have a size larger than the accommodation portion 36 and includes a flange portion 38 that projects from a periphery of the accommodation portion 36. More specifically, the flange portion 38 includes a pair of first flange portions 38A extending in the longitudinal direction of the exterior portion 32 and a pair of second flange portions 38B extending in the lateral direction of the exterior portion 32.

As shown in FIG. 5, the switch unit 18 includes the outer case 28, the inner case 30, a plurality of first screws 40, a seal member 42, a flexible cable 44, a plurality of switch members 46, a switch member 48, a plurality of second screws 50, an attachment member 52, a plurality of click members 54, a holding member 56, a plurality of double-sided tapes 58, a plurality of operation portions 24, and the operation portion 26.

The plurality of first screws 40 are screws provided to fix the case portion 34 of the outer case 28 and the inner case 30. The seal member 42 is interposed between the case portion 34 of the outer case 28 and the inner case 30 and seals a space between the case portion 34 and the inner case 30. The flexible cable 44 includes a plurality of input portions 60 and an output portion 62. The plurality of input portions 60 and the output portion 62 are connected to each other by a wiring member (not shown). The output portion 62 is connected to, for example, a control substrate (not shown) provided in the lens device 10. The switch members 46 constitute switch bodies of the slide switches 20, respectively and the switch member 48 constitutes a switch body of the push-button switch 22. The switch members 46 and the switch member 48 are connected to the input portions 60, respectively.

The click members 54 are members that impart a click feeling with respect to the respective operation portions 24 of the slide switches 20, respectively and are formed of sheet metals. The second screws 50 are screws provided to fix the click members 54 to the outer case 28, respectively. A plurality of openings 64 and an opening 66 are formed in the outer case 28. Each opening 64 penetrates in a plate thickness direction of the outer case 28 and is open to an outer peripheral side and an inner peripheral side of the outer case 28. Similarly, the opening 66 also penetrates in the plate thickness direction of the outer case 28 and is open to the outer peripheral side and the inner peripheral side of the outer case 28.

The respective operation portions 24 of the slide switches 20 are provided on the outer peripheral side of the outer case 28 and are fixed to the click members 54 by the double-sided tapes 58 via the openings 64. The click members 54 are attached to the respective switch members 46 of the slide switches 20, respectively. The holding member 56 is fixed to the switch member 48 of the push-button switch 22 via the attachment member 52. The operation portion 26 of the push-button switch 22 is held by the holding member 56 and is exposed on the outer peripheral side of the outer case 28 via the opening 66.

Next, a fixation structure for fixation of the switch unit 18 to the fixation frame 16 will be described. As described above, the direction along the arrow X is the direction along the optical axis OA. A direction along an arrow Y is an attachment direction in which the switch unit 18 is attached to the fixation frame 16. An arrow Y1 side is a front side in the attachment direction, and an arrow Y2 side is a rear side in the attachment direction. A direction along an arrow Z is a direction along a tangential direction of the fixation frame 16. An arrow Z1 side is a first side in the tangential direction of the fixation frame 16 and an arrow Z2 side is a second side in the tangential direction of the fixation frame 16. The direction along the arrow X, the direction along the arrow Y, and the direction along the arrow Z are directions orthogonal to each other.

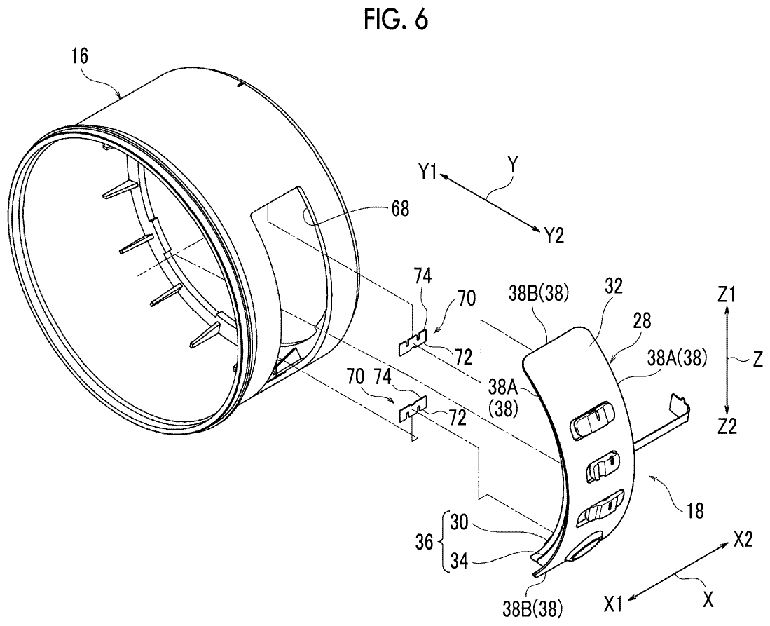

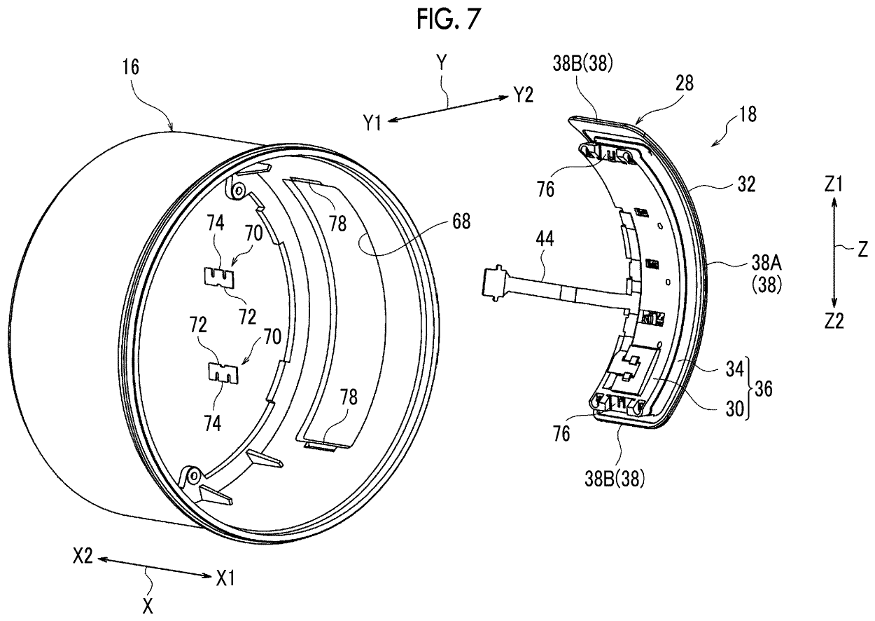

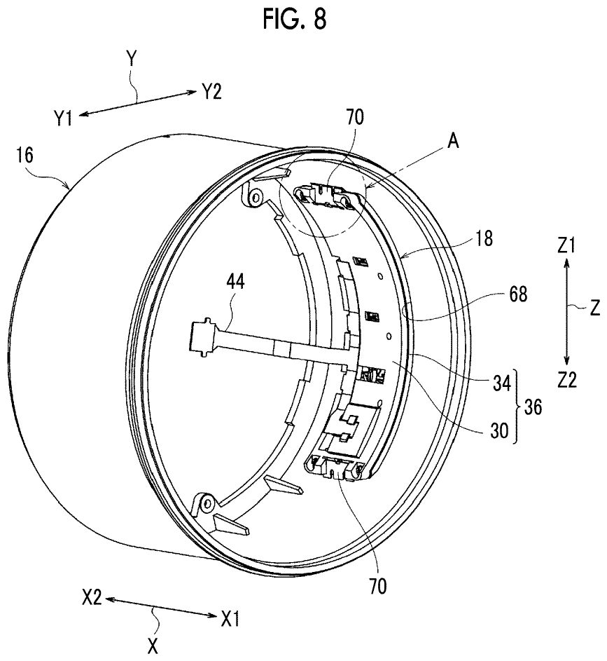

As shown in FIGS. 6 to 8, the fixation frame 16 includes an opening 68. The opening 68 is formed by a hole that penetrates in the direction along the arrow Y. The opening 68 is formed in a rectangular shape corresponding to an outer shape portion of the inner case 30. The direction along the arrow Y corresponds to a direction along the radial direction of the fixation frame 16. Note that the opening 68 may be formed by a notch that penetrates in the radial direction of the fixation frame 16.

An outer shape portion of the outer case 28 is formed to be larger than the opening 68, and the outer shape portion of the inner case 30 is formed to be smaller than the opening 68. The outer shape portion of the outer case 28 is formed by an outer peripheral portion of the flange portion 38. The outer shape portion of the inner case 30 is formed by an outer peripheral portion of the inner case 30. In addition, an outer shape portion of the case portion 34 is also formed to be smaller than the opening 68. The outer shape portion of the case portion 34 is formed by an outer peripheral portion of the case portion 34. The inner case 30 and the case portion 34 are configured to be insertable into the opening 68 from the outside of the fixation frame 16 since the outer shape portions thereof are formed to be smaller than the opening 68. The switch unit 18 is unitized in a stage before insertion of the inner case 30 and the case portion 34 (that is, the accommodation portion 36) into the opening 68.

The switch unit 18 is mounted to the fixation frame 16 with the inner case 30 and the case portion 34 inserted into the opening 68. In a state where the switch unit 18 is mounted to the fixation frame 16, the flange portion 38 of the outer case 28 overlaps a peripheral edge portion of the opening 68 from the outside of the fixation frame 16. The flange portion 38 is an example of an “overlapping portion” according to the embodiment of the present disclosed technology. In addition, in a state where the switch unit 18 is mounted to the fixation frame 16, the outer case 28 is disposed to face the outside of the fixation frame 16 and the inner case 30 is disposed to face the inside of the fixation frame 16. That is, the outer case 28 is exposed to the outside of the fixation frame 16, and the inner case 30 is exposed to the inside of the fixation frame 16.

The lens device 10 includes a pair of fixing members 70. The switch unit 18 is fixed to the fixation frame 16 by the pair of fixing members 70 in a state of being mounted to the fixation frame 16. Specifically, each fixing member 70 includes a fixing target portion 72 and a fitting target portion 74. The inner case 30 of the switch unit 18 includes a pair of fixation portions 76, and an inner peripheral surface of the fixation frame 16 includes a pair of fitting portions 78. In a state where the inner case 30 and the case portion 34 are inserted into the opening 68 and the switch unit 18 is mounted to the fixation frame 16, the respective fixing target portions 72 of the fixing members 70 are respectively fixed to the fixation portions 76 and the respective fitting target portions 74 of the fixing members 70 are respectively fitted into the fitting portions 78, so that the switch unit 18 is fixed to the fixation frame 16.

One of the pair of fixation portions 76 is provided at a first end portion of the inner case 30 and the other of the pair of fixation portions 76 is provided at a second end portion of the inner case 30, the second end portion being on a side opposite to the first end portion. The first end portion of the inner case 30 is an end portion of the inner case 30 that is positioned on one side in a circumferential direction of the fixation frame 16, and the second end portion of the inner case 30 is an end portion of the inner case 30 that is positioned on the other side in the circumferential direction of the fixation frame 16. The first end portion is an example of a “first end portion of the switch portion” according to the embodiment of the present disclosed technology and the second end portion is an example of a “second end portion of the switch portion” according to the embodiment of the present disclosed technology.

One of the pair of fixing members 70 is fixed to the one of the fixation portions 76 and is disposed at the first end portion of the inner case 30 and the other of the pair of fixing members 70 is fixed to the other of the fixation portions 76 and is disposed at the second end portion of the inner case 30. Since the one of the fixing members 70 is disposed at the first end portion of the inner case 30 and the other of the fixing members 70 is disposed at the second end portion of the inner case 30, the pair of fixing members 70 is disposed such that the fixing members 70 are separated from each other in the circumferential direction of the fixation frame 16. In other words, the pair of fixing members 70 is disposed such that the fixing members 70 are separated from each other in the direction along the arrow Z, which is the tangential direction of the fixation frame 16. One of the pair of fitting portions 78 is formed at a position corresponding to the one of the fixation portions 76, and the other of the pair of fitting portions 78 is formed at a position corresponding to the other of the fixation portions 76.

Note that although the pair of fixing members 70 is used for fixation of the switch unit 18 to the fixation frame 16, the number of fixing members 70 used for the fixation may be three or more. The number of fixing members 70 may be any number. Hereinafter, a case where the pair of fixing members 70 is used will be described as an example. The pair of fixing members 70 is an example of a “plurality of fixing members” according to the embodiment of the present disclosed technology. The one of the fixing members 70 is an example of a “first fixing member” according to the embodiment of the present disclosed technology. The other of the fixing members 70 is an example of a “second fixing member” according to the embodiment of the present disclosed technology.

A fixation structure via which the one of the fixing members 70 is fixed to the switch unit 18 and a fixation structure via which the other of the fixing members 70 is fixed to the switch unit 18 are configured to be symmetrical in the direction along the arrow Z. Similarly, a fitting structure via which the one of the fixing members 70 is fitted to the fixation frame 16 and a fitting structure via which the other of the fixing members 70 is fitted to the fixation frame 16 are configured to be symmetrical in the direction along the arrow Z. Hereinafter, one of a pair of fixation structures that is on the arrow Z1 side will be described and description about the other of the pair of fixation structures that is on the arrow Z2 side will be omitted. Similarly, one of a pair of fitting structures that is on the arrow Z1 side will be described and description about the other of the pair of fitting structures that is on the arrow Z2 side will be omitted.

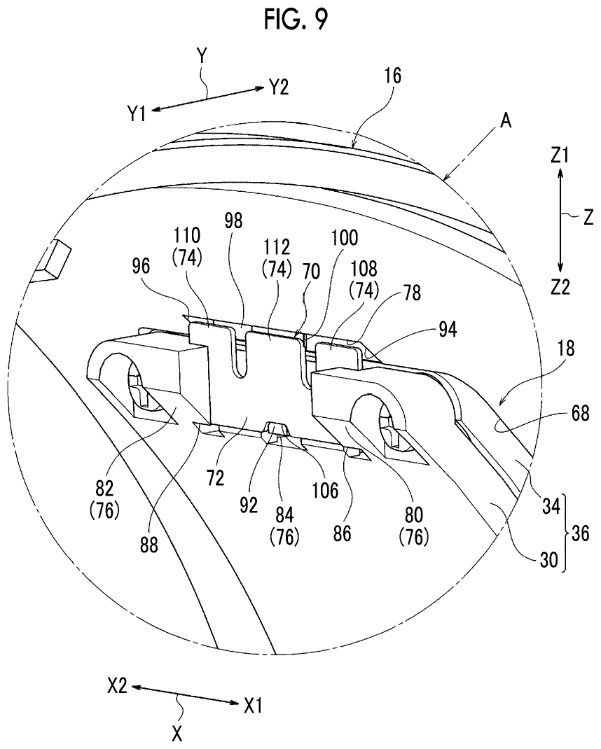

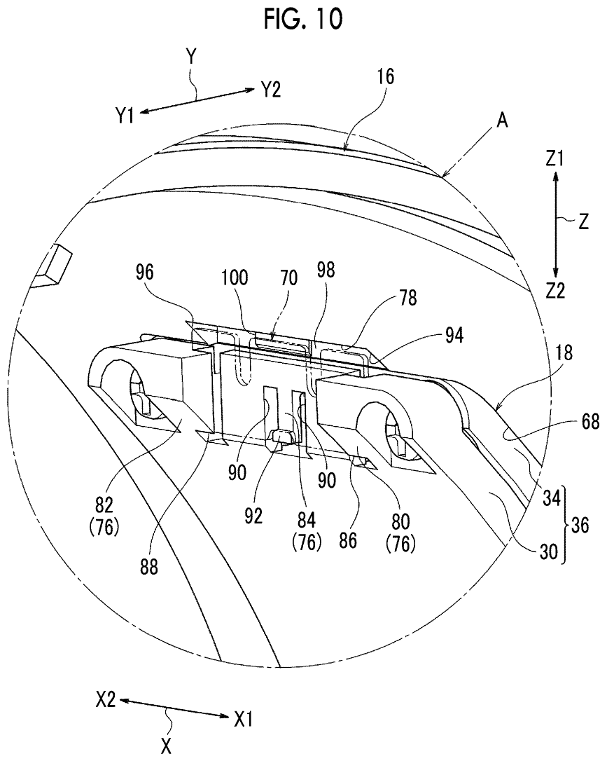

As shown in FIGS. 9 and 10, the fixation portion 76 for fixation of the fixing member 70 to the switch unit 18 is formed at the inner case 30. Since the fixation portion 76 is formed at the inner case 30, the fixation portion 76 faces the inside of the fixation frame 16. That is, the fixation portion 76 is exposed to the inside of the fixation frame 16.

The fixation portion 76 includes a first fixation portion 80, a second fixation portion 82, and a snap-fit portion 84. The first fixation portion 80 is formed at a first end portion of the fixation portion 76 that is on the arrow X1 side, and the second fixation portion 82 is formed at a second end portion of the fixation portion 76 that is on the arrow X2 side. The first fixation portion 80 and the second fixation portion 82 are positioned on both sides with respect to the snap-fit portion 84 in the direction along the arrow X. Specifically, the first fixation portion 80 is positioned on the arrow X1 side with respect to the snap-fit portion 84 and the second fixation portion 82 is positioned on the arrow X2 side with respect to the snap-fit portion 84.

The first fixation portion 80 includes a first groove 86 extending along the direction along the arrow Z. Similarly, the second fixation portion 82 includes a second groove 88 extending along the direction along the arrow Z. Each of the first groove 86 and the second groove 88 penetrates in the direction along the arrow Z. In addition, the first groove 86 is open on the second groove 88 side (that is, the arrow X2 side), and the second groove 88 is open on the first groove 86 side (that is, the arrow X2 side).

The snap-fit portion 84 is formed by an elastic piece extending in the direction along the arrow Z. The snap-fit portion 84 is positioned at a central portion between the first fixation portion 80 and the second fixation portion 82 in the direction along the arrow X. A pair of slits 90 is formed such that the slits 90 are on both sides with respect to the snap-fit portion 84 in the direction along the arrow X. The pair of slits 90 extends in the direction along the arrow Z. Each slit 90 penetrates in the direction along the arrow Y.

An end portion of the snap-fit portion 84 that is on the arrow Z1 side is a connection end connected to the inner case 30, and an end portion of the snap-fit portion 84 that is on the arrow Z2 side is a free end not connected to the inner case 30. A protrusion portion 92 is formed at the free end of the snap-fit portion 84. The protrusion portion 92 protrudes from the free end of the snap-fit portion 84 toward the arrow Y1 side.

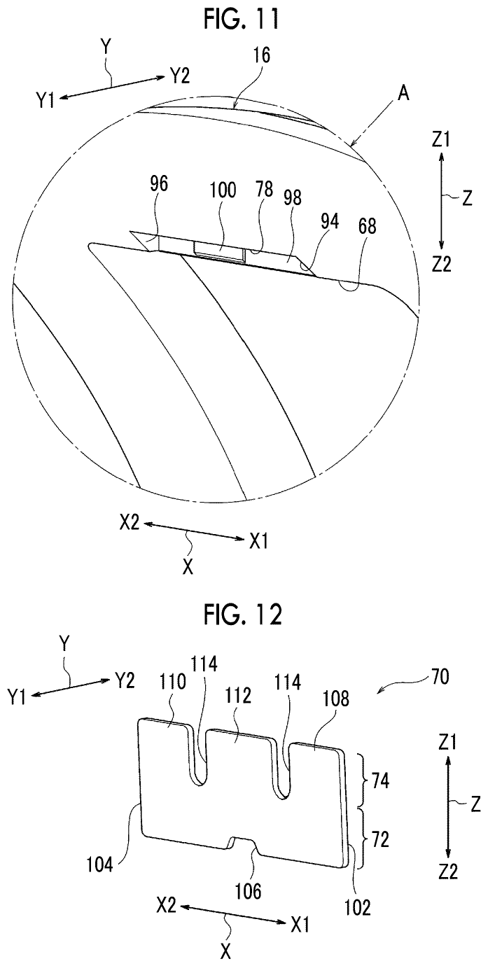

As shown in FIGS. 10 and 11, the fitting portion 78 for fixation of the fixing member 70 to the fixation frame 16 is formed at the inner peripheral surface of the fixation frame 16. The fitting portion 78 is formed in a recessed shape. The fitting portion 78 is formed to be adjacent to the opening 68. Specifically, the fitting portion 78 is formed on an edge portion of the peripheral edge portion of the opening 68 on the arrow Z1 side with respect to the opening 68 in the inner peripheral surface of the fixation frame 16. The fitting portion 78 is formed to be open on the arrow Z2 side. Since the fitting portion 78 is formed in the recessed shape, the fitting portion 78 is not exposed at an outer peripheral surface of the fixation frame 16. That is, the fitting portion 78 does not penetrate in the radial direction of the fixation frame 16 and ends at a position inward of the outer peripheral surface of the fixation frame 16.

A side surface that is one of inner surfaces of the recessed fitting portion 78 and that is on the arrow X1 side is formed as a first locking portion 94 and a side surface that is one of the inner surfaces and that is on the arrow X2 side is formed as a second locking portion 96. The first locking portion 94 and the second locking portion 96 are examples of “locking portions” according to the embodiment of the present disclosed technology.

In addition, a contact portion 100 is formed on a side surface 98, which is one of the inner surfaces of the recessed fitting portion 78 and is on the arrow Y2 side. The contact portion 100 is formed at a central portion of the side surface 98 in the direction along the arrow X, and is formed in a protrusion-like shape protruding from the side surface 98 toward the arrow Y1 side.

As shown in FIG. 12, the fixing member 70 is formed in a plate-like shape. The fixing member 70 is made of, for example, a metal, and is composed of a sheet metal member manufactured by using a sheet metal. The fixing member 70 includes the fixing target portion 72 and the fitting target portion 74. The fixing target portion 72 is a portion that is fixed to the fixation portion 76 (refer to FIG. 10) and is composed of a portion of the fixing member 70 that is on the arrow Z2 side. The fitting target portion 74 is a portion that is fitted to the fitting portion 78 (refer to FIG. 11) and is composed of a portion of the fixing member 70 that is on the arrow Z1 side.

The fixing target portion 72 includes a first fixing target portion 102 and a second fixing target portion 104. The first fixing target portion 102 is formed by an end portion of the fixing target portion 72 that is on the arrow X1 side, and the second fixing target portion 104 is formed by an end portion of the fixing target portion 72 that is on the arrow X2 side.

In addition, the fixing target portion 72 includes a notched portion 106. The notched portion 106 is formed at an end portion of the fixing target portion 72 that is on the arrow Z2 side. The notched portion 106 penetrates in the direction along the arrow Y and is open on the arrow Z2 side. The notched portion 106 is positioned at a central portion of the fixing target portion 72 in the direction along the arrow X.

The fitting target portion 74 includes a first hooked portion 108, a second hooked portion 110, and an elastic portion 112. The first hooked portion 108, the second hooked portion 110, and the elastic portion 112 are arranged in the direction along the arrow X. For example, the first hooked portion 108 is positioned on the arrow X1 side with respect to the elastic portion 112, and the second hooked portion 110 is positioned on the arrow X2 side with respect to the elastic portion 112. The elastic portion 112 is positioned between the first hooked portion 108 and the second hooked portion 110 in the direction along the arrow X.

Note that although the fitting target portion 74 includes the first hooked portion 108 and the second hooked portion 110, the fitting target portion 74 may include one hooked portion or three or more hooked portions. The number of hooked portions may be any number. Hereinafter, a case where the fitting target portion 74 includes the first hooked portion 108 and the second hooked portion 110 will be described as an example. The first hooked portion 108 and the second hooked portion 110 are examples of a “plurality of hooked portions” according to the embodiment of the present disclosed technology.

A slit 114 is formed between the first hooked portion 108 and the elastic portion 112. Similarly, the slit 114 is also formed between the second hooked portion 110 and the elastic portion 112. Each slit 114 extends along the direction along the arrow Z. With a pair of slits 114 formed at the fitting target portion 74, the first hooked portion 108, the second hooked portion 110, and the elastic portion 112 are formed at the fitting target portion 74. Each of the first hooked portion 108, the second hooked portion 110, and the elastic portion 112 is formed by an elastic piece extending in the direction along the arrow Z. The direction along the arrow Z is an example of a “direction along a direction intersecting an optical axis” according to the embodiment of the present disclosed technology.

In addition, in a state where the switch unit 18 is mounted to the fixation frame 16, the switch unit 18 is fixed to the fixation frame 16 by means of the fixing member 70 in a manner as follows. First, the first hooked portion 108 and the second hooked portion 110 are inserted into the first groove 86 and the second groove 88 from the arrow Z2 side. In a case where the first fixing target portion 102 and the second fixing target portion 104 are inserted into the first groove 86 and the second groove 88 from the arrow Z2 side, the elastic portion 112 comes into contact with the protrusion portion 92 of the snap-fit portion 84 and thus the snap-fit portion 84 is elastically deformed toward the arrow Y2 side.

Then, in a case where tip portions of the first hooked portion 108 and the second hooked portion 110 pass through the first groove 86 and the second groove 88, the first fixing target portion 102 and the second fixing target portion 104 are inserted into the first groove 86 and the second groove 88. Note that base end portions of the first hooked portion 108 and the second hooked portion 110 are also inserted into the first groove 86 and the second groove 88. In addition, in a case where the protrusion portion 92 rides over the elastic portion 112 and the fixing target portion 72, the snap-fit portion 84 is deformed toward the arrow Y1 side to restore the original shape thereof and the protrusion portion 92 is inserted into the notched portion 106. Accordingly, the protrusion portion 92 is locked to the notched portion 106 from the arrow Z2 side. In a case where the first fixing target portion 102 and the second fixing target portion 104 are inserted into the first groove 86 and the second groove 88 and the protrusion portion 92 is locked to the notched portion 106, the fixing target portion 72 is fixed to the fixation portion 76. In this manner, the fixing target portion 72 is fixed to the fixation portion 76 from the arrow Z2 side.

In addition, in a case where the tip portions of the first hooked portion 108 and the second hooked portion 110 pass through the first groove 86 and the second groove 88, the tip portions are hooked onto the side surface 98 of the fitting portion 78 from the arrow Y1 side. Furthermore, the elastic portion 112 comes into contact with the contact portion 100 and thus the elastic portion 112 is elastically deformed toward the arrow Y1 side. The contact portion 100 has a shape that elastically deforms the elastic portion 112 toward the arrow Y1 side. With the first hooked portion 108 and the second hooked portion 110 hooked onto the side surface 98 of the fitting portion 78 and the elastic portion 112 coming into contact with the contact portion 100 to be elastically deformed, the fitting target portion 74 is fitted to the fitting portion 78. In this manner, the fitting target portion 74 is fitted to the fitting portion 78 from the arrow Z2 side. Furthermore, in a state where the fitting target portion 74 is fitted to the fitting portion 78, the first hooked portion 108 is locked to the first locking portion 94 from the arrow X2 side, and the second hooked portion 110 is locked to the second locking portion 96 from the arrow X1 side. The first hooked portion 108 and the second hooked portion 110 are examples of “locking target portions” according to the embodiment of the present disclosed technology.

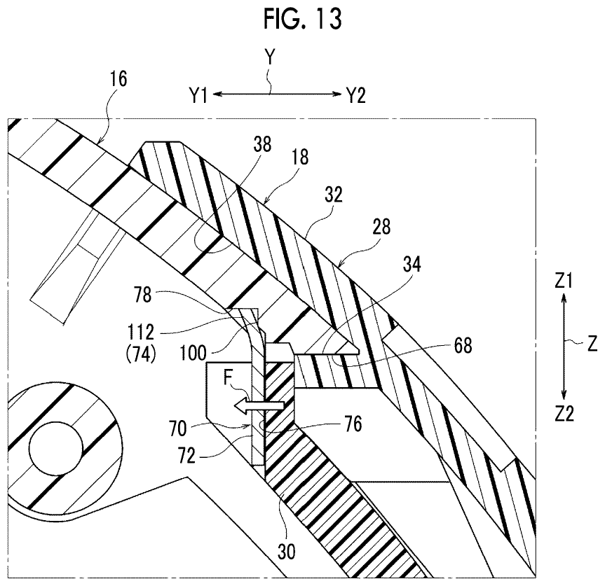

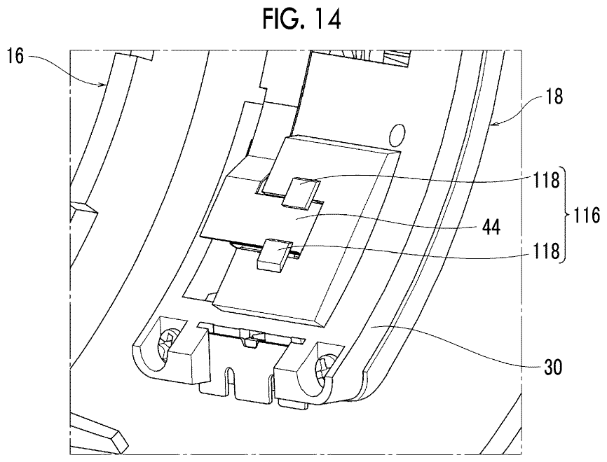

In the above-described manner, the switch unit 18 is fixed to the fixation frame 16 by means of the fixing member 70 in a state of being mounted to the fixation frame 16. As shown in FIG. 13, in a state where the switch unit 18 is fixed to the fixation frame 16 by means of the fixing member 70, the elastic portion 112 comes into contact with the contact portion 100 to be elastically deformed toward the arrow Y1 side and thus a pulling force F, which is a force that pulls the switch unit 18 toward the inside of the fixation frame 16 (that is, the arrow Y1 side), acts on the switch unit 18.

In a case where the pulling force F acts on the switch unit 18, the flange portion 38 of the outer case 28 overlaps the peripheral edge portion of the opening 68 from the outside of the fixation frame 16 (that is, the arrow Y2 side). In addition, the first hooked portion 108 and the second hooked portion 110 are hooked onto the side surface 98 of the fitting portion 78 in such a direction that the switch unit 18 is restrained from falling out to the outside of the fixation frame 16 (that is, the arrow Y2 side) (refer to FIG. 9). That is, the switch unit 18 is fixed to the fixation frame 16 in a state where the fixation frame 16 is interposed between the fixing member 70 and the flange portion 38.

As described above, in the lens device 10, a screwless fitting structure, in which no screw is used, is used for the fixation structure for fixation of the switch unit 18 to the fixation frame 16. In addition, in the fitting structure, a structure in which the fitting portion 78 is formed at the inner peripheral surface of the fixation frame 16 and the fitting target portion 74 is fitted to the fitting portion 78 from the inside of the fixation frame 16 is adopted. Furthermore, in the fitting structure, the direction along the arrow Z is set as a direction in which the fitting target portion 74 is fitted to the fitting portion 78. The direction along the arrow Z is an example of a “direction along a direction intersecting an optical axis” according to the embodiment of the present disclosed technology.

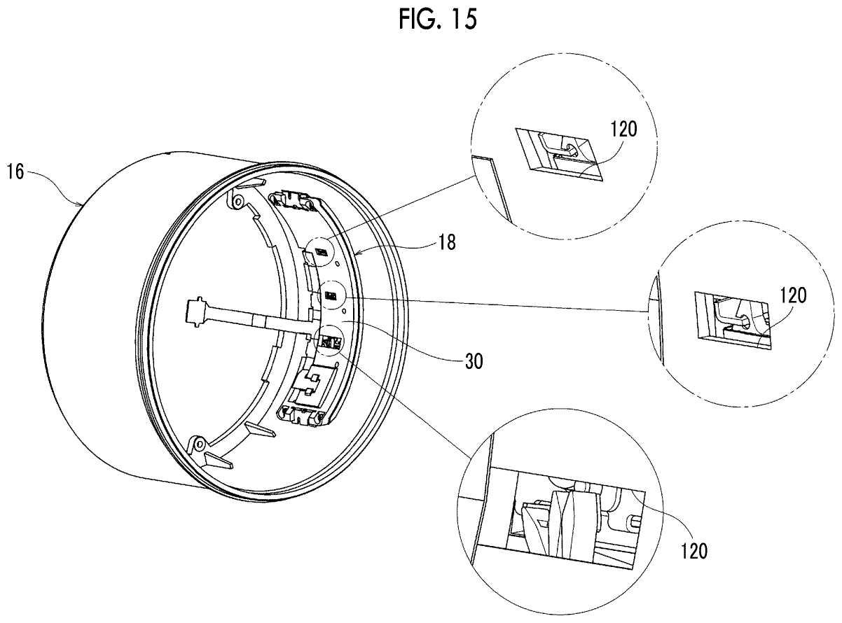

Note that as shown in FIG. 14, a holding portion 116 that holds a part of the flexible cable 44 is formed at the inner case 30. The holding portion 116 is formed by a pair of claw portions 118. In addition, as shown in FIG. 15, a plurality of window portions 120 are formed in the inner case 30. Each window portion 120 is open at a position corresponding to the slide switch 20. Each window portion 120 faces the inside of the fixation frame 16. That is, each window portion 120 is exposed to the inside of the fixation frame 16.

Next, an assembling method of the lens device 10 of the present embodiment will be described.

The assembling method of the lens device 10 of the present embodiment includes an assembling step of assembling the lens barrel 12 and an attaching step of attaching the plurality of lenses 14 inside the lens barrel 12. The attaching step includes a mounting step of inserting the inner case 30 into the opening 68 from the outside of the fixation frame 16 and mounting the switch unit 18 to the fixation frame 16 and a fixing step of fixing the switch unit 18 to the fixation frame 16 by means of the pair of fixing members 70.

The fixing step includes a fitting step of respectively fixing the pair of fixing members 70 to the fixation portions 76 from the inside of the fixation frame 16 and respectively fitting the fitting target portions 74 of the pair of fixing members 70 to the fitting portions 78. The fitting step includes bringing the elastic portions 112 of the fitting target portions 74 into contact with the contact portions 100 of the fitting portions 78 so that the elastic portions 112 are elastically deformed and hooking the first hooked portions 108 and the second hooked portions 110 onto the side surfaces 98 of the fitting portions 78. Note that the assembling method of the lens device 10 of the present embodiment is an example of a “manufacturing method of a lens device” according to the embodiment of the present disclosed technology.

Next, the effects of the present embodiment will be described.
(1) As described above, in the lens device 10 according to the present embodiment, the fixing member 70 is used to fix the switch unit 18 to the fixation frame 16. The fixation frame 16 includes the fitting portion 78, and the fixing member 70 includes the fixing target portion 72 that is fixed to the fixation portion 76 of the switch unit 18 and the fitting target portion 74 that is fitted to the fitting portion 78. Therefore, it is possible to fix the switch unit 18 to the fixation frame 16 by fixing the fixing target portion 72 of the fixing member 70 to the fixation portion 76 and fitting the fitting target portion 74 of the fixing member 70 to the fitting portion 78.
(2) The fitting target portion 74 includes the elastic portion 112 having elasticity and the fitting portion 78 includes the contact portion 100 that comes into contact with the elastic portion 112 such that the elastic portion 112 is elastically deformed. Therefore, since the elastic portion 112 is elastically deformed, the fitting target portion 74 can be firmly fitted to the fitting portion 78 in comparison with, for example, a case where the fitting target portion 74 is fitted to the fitting portion 78 without elastic deformation of the elastic portion 112. Accordingly, it is not necessary to use screws to fix the switch unit 18 to the fixation frame 16.
(3) The fixation structure for fixation of the fixation frame 16 and the switch unit 18 is the fitting structure in which the fitting portion 78 and the fitting target portion 74 are used. Therefore, it is not necessary to use screws to fix the switch unit 18 to the fixation frame 16 and thus it is possible to avoid various problems that are caused in a case where screws are loosened due to aging. Furthermore, it is also possible to avoid various problems as described in (4) to (6) below, which are caused in a case where screws are used.
(4) For example, in a case where screws are used to fix the switch unit 18 to the fixation frame 16 and the switch unit 18 is fixed to the fixation frame 16 by means of the screws from the outside of the fixation frame 16, the screws are exposed to the outside of the fixation frame 16, and thus the appearance of a peripheral portion of the switch unit 18 may be deteriorated. However, in a case where no screws are used to fix the switch unit 18 to the fixation frame 16, it is possible to avoid the deterioration in appearance of the peripheral portion of the switch unit 18.
(5) For example, in a case where the switch unit 18 is fixed to the fixation frame 16 by means of screws from the inside of the fixation frame 16 for the purpose of avoiding the deterioration in appearance of the peripheral portion of the switch unit 18, a driver is inserted into the fixation frame 16 in an oblique direction with respect to an optical axis of the fixation frame 16 and the screws are tightened by means of the driver. However, in such a case, the fixation frame 16 may be damaged due to a tip of the driver that collides with the fixation frame 16 or the flexible cable 44 may be damaged due to the tip of the driver that is caught by the flexible cable 44 in a case where the driver is inserted into the fixation frame 16. However, in a case where no screws are used to fix the switch unit 18 to the fixation frame 16, it is possible to avoid the damage to the fixation frame 16 that is caused by the tip of the driver that collides with the fixation frame 16 and the damage to the flexible cable 44 that is caused by the tip of the driver that is caught by the flexible cable 44.
(6) For example, in a case where the switch unit 18 is fixed to the fixation frame 16 by means of screws at a plurality of positions separated from each other in the circumferential direction of the fixation frame 16, the roundness of the fixation frame 16 may be deteriorated due to fastening forces caused by the screws at the plurality of positions and thus there may be a decrease in operability of an operation ring (not shown) provided at the lens device 10. However, in a case where no screws are used to fix the switch unit 18 to the fixation frame 16, it is possible to suppress the deterioration in roundness of the fixation frame 16 and thus it is possible to suppress the decrease in operability of the operation ring.
(7) The switch unit 18 includes the outer case 28 that is disposed to face the outside of the fixation frame 16 and the inner case 30 that is disposed to face the inside of the fixation frame 16 and the fixation frame 16 includes the opening 68. The outer shape portion of the outer case 28 is larger than the opening 68, and the outer shape portion of the inner case 30 is smaller than the opening 68. Therefore, even in a case where the outer case 28 is mounted to the inner case 30 so that the switch unit 18 is unitized in a stage before the mounting of the switch unit 18 to the fixation frame 16, the switch unit 18 can be mounted to the fixation frame 16.
(8) The outer case 28 has an overlapping portion that overlaps the peripheral edge portion of the opening 68 from the outside of the fixation frame 16. Therefore, it is possible to restrain the outer case 28 from wobbling with respect to the fixation frame 16 in a state where the switch unit 18 is mounted to the fixation frame 16. Accordingly, it is possible to improve workability related to a case where the fitting target portion 74 is fitted to the fitting portion 78 in a state where the switch unit 18 is mounted to the fixation frame 16. In addition, since it is possible to suppress formation of a gap between the outer case 28 and the fixation frame 16 with the overlapping portion, it is possible to restrain a foreign substance from infiltrating into a space between the outer case 28 and the fixation frame 16.
(9) The switch unit 18 is unitized in a stage before insertion of the inner case 30 and the case portion 34 into the opening 68. Therefore, for example, it is possible to improve workability in the case of assembly in comparison with a case where the switch unit 18 is not unitized in a stage before insertion of the inner case 30 into the opening 68 and members (for example, the outer case 28, the inner case 30, and the like) constituting the switch unit 18 are separately mounted to the fixation frame 16.
(10) The switch unit 18 includes the window portions 120 that are open at positions corresponding to the slide switches 20. The window portions 120 are formed at the inner case 30 disposed to face the inside of the fixation frame 16. Therefore, in a state where the switch unit 18 is mounted to the fixation frame 16, the positions of the respective operation portions 24 of the slide switches 20 can be checked from the inside of the fixation frame 16 through the window portions 120.
(11) The pair of fixing members 70 is used to fix the switch unit 18 to the fixation frame 16. One of the pair of fixing members 70 is fixed to the fixation portion 76 provided at the first end portion of the inner case 30 and the other of the pair of fixing members 70 is fixed to the fixation portion 76 provided at the second end portion of the inner case 30. Therefore, the switch unit 18 can be fixed to the fixation frame 16 at two positions of the first end portion and the second end portion of the inner case 30 and thus the switch unit 18 can be stably fixed to the fixation frame 16 in comparison with, for example, a case where the switch unit 18 is fixed to the fixation frame 16 at one position. In addition, a space for disposition of the pair of fixing members 70 can be made small in comparison with, for example, a case where one fixing member (that is, one fixing member that extends in the direction along the arrow Z from one fixation portion 76 to the other fixation portion 76) that has a configuration obtained by connecting the pair of fixing members 70 to each other. Therefore, the size of the lens device 10 can be reduced.
(12) The switch unit 18 includes the fixation portion 76 and the fixing member 70 includes the fixing target portion 72 that is fixed to the fixation portion 76. A snap-fit structure in which the snap-fit portion 84, which is an elastic piece, is used is applied for the fixation portion 76. Therefore, it is possible to firmly fix the fixing target portion 72 to the fixation portion 76 in comparison with, for example, a case where the snap-fit structure is not applied for the fixation portion 76 and thus it is possible to restrain the fixing member 70 from falling off the switch unit 18 due to shock or aging.
(13) The fixation portion 76 provided at the switch unit 18 faces the inside of the fixation frame 16. Therefore, it is possible to avoid the deterioration in appearance of the peripheral portion of the switch unit 18 in comparison with, for example, a case where the fixation portion 76 faces the outside of the fixation frame 16.
(14) The fixation portion 76 includes the first fixation portion 80 formed at the first end portion of the fixation portion 76 that is on the arrow X1 side and the second fixation portion 82 formed at the second end portion of the fixation portion 76 that is on the arrow X2 side and the fixing target portion 72 includes the first fixing target portion 102 fixed to the first fixation portion 80 and the second fixing target portion 104 fixed to the second fixation portion 82. Therefore, the fixing target portion 72 can be stably fixed to the fixation portions 76 in comparison with, for example, a case where the fixing target portion 72 is fixed to the fixation portion 76 at one position.
(15) The fitting portion 78 is formed at the inner peripheral surface of the fixation frame 16 and the fitting portion 78 is not exposed at the outer peripheral surface of the fixation frame 16. Therefore, it is possible to avoid the deterioration in appearance of the peripheral portion of the switch unit 18 in comparison with, for example, a case where the fitting portion 78 is exposed at the outer peripheral surface.
(16) The direction along the arrow Z is set as a direction in which the fitting target portion 74 is fitted to the fitting portion 78. Therefore, for example, an operator can fit the fitting target portion 74 to the fitting portion 78 by pushing the fixing member 70 in the direction along the arrow Z with a finger.
(17) The fitting portion 78 is formed in a recessed shape. Therefore, it is possible to restrain the fitting portion 78 from protruding to the inside of the fixation frame 16 in comparison with, for example, a case where the fitting portion 78 is formed in a protruding shape.
(18) The fitting portion 78 includes the first locking portion 94 and the second locking portion 96 and the fitting target portion 74 includes the first hooked portion 108 and the second hooked portion 110 that are engaged with the first locking portion 94 and the second locking portion 96 in the direction along the arrow X. Therefore, it is possible to restrain the fitting target portion 74 from wobbling with respect to the fitting portion 78 in the direction along the arrow X in a state where the fitting target portion 74 is fitted to the fitting portion 78.
(19) The contact portion 100 has a shape that elastically deforms the elastic portion 112 in a direction in which the switch unit 18 is pulled toward the inside of the fixation frame 16. Therefore, in a case where the elastic portion 112 comes into contact with the contact portion 100, the pulling force F, which is a force that pulls the switch unit 18 toward the inside of the fixation frame 16, can be generated by the elastic portion 112. Accordingly, the switch unit 18 can be fixed to the fixation frame 16 in a state of being pulled toward the inside of the fixation frame 16.
(20) The fitting target portion 74 includes the first hooked portion 108 and the second hooked portion 110 that are hooked onto the fitting portion 78. Therefore, the first hooked portion 108 and the second hooked portion 110 are hooked onto the fitting portion 78 and thus the switch unit 18 can be restrained from falling out to the outside of the fixation frame 16 by the first hooked portion 108 and the second hooked portion 110. In addition, since the fitting target portion 74 can be hooked onto the fitting portion 78 at two positions that are at the first hooked portion 108 and the second hooked portion 110, a retaining force with respect to the switch unit 18 can be increased in comparison with, for example, a case where the fitting target portion 74 is hooked onto the fitting portion 78 at one position.
(21) The first hooked portion 108 is adjacent to the elastic portion 112 on the arrow X1 side and the second hooked portion 110 is adjacent to the elastic portion 112 on the arrow X2 side. Therefore, since the first hooked portion 108 and the second hooked portion 110 are disposed on both sides with respect to the elastic portion 112 in the direction along the arrow X, a retaining force with respect to the switch unit 18 can be exerted in a balanced manner in comparison with, for example, a case where the fitting target portion 74 is hooked onto the fitting portion 78 on one side with respect to the elastic portion 112.

Note that contents described and shown above are for detailed description of a part according to the present disclosed technology and are merely an example of the present disclosed technology. For example, description of the above-described configurations, functions, actions, and effects is description related to an example of configurations, functions, actions, and effects of parts related to the present disclosed technology. Therefore, it is a matter of course that an unnecessary part of the contents described and illustrated above may be deleted, a new element may be added, and replacement may be made without departing from the spirit of the present disclosed technology. In addition, in order to avoid complication and facilitate the understanding of a portion according to the present disclosed technology, regarding the contents described and illustrated above, description related to common technical knowledge or the like which does not need to be described to enable implementation of the present disclosed technology has been omitted.

What is claimed is:

1. A lens device comprising:
a fixation frame;
a switch portion; and
a fixing member that fixes the fixation frame and the switch portion to each other,
wherein the fixation frame includes a fitting portion,
the fixing member includes a fitting target portion that is fitted to the fitting portion,
the fitting target portion includes an elastic portion having elasticity, and
the fitting portion includes a contact portion that comes into contact with the elastic portion so that the elastic portion is elastically deformed.

2. The lens device according to claim 1,
wherein the switch portion includes
an outer member that is disposed to face an outside of the fixation frame, and
an inner member that is disposed to face an inside of the fixation frame.

3. The lens device according to claim 2,
wherein the fixation frame includes an opening,
an outer shape portion of the outer member is larger than the opening, and
an outer shape portion of the inner member is smaller than the opening.

4. The lens device according to claim 3,
wherein the outer member includes an overlapping portion that overlaps a peripheral edge portion of the opening from the outside of the fixation frame.

5. The lens device according to claim 3,
wherein the switch portion is a switch unit that is unitized in a stage before insertion of the inner member into the opening.

6. The lens device according to claim 1,
wherein the switch portion includes
a slide switch as a switch related to an operation performed on a lens, and
a window portion that faces an inside of the fixation frame and that is open at a position corresponding to the slide switch.

7. The lens device according to claim 6,
wherein the switch portion includes an inner member that is disposed to face the inside of the fixation frame, and
the window portion is formed at the inner member.

8. The lens device according to claim 1,
wherein a plurality of the fixing members are provided, and
the plurality of fixing members include
a first fixing member that is disposed at a first end portion of the switch portion, and
a second fixing member that is disposed at a second end portion of the switch portion.

9. The lens device according to claim 1,
wherein the switch portion includes a fixation portion, and
the fixing member includes a fixing target portion that is fixed to the fixation portion.

10. The lens device according to claim 9,
wherein the fixation portion faces an inside of the fixation frame.

11. The lens device according to claim 10,
wherein the fixation portion includes
a first fixation portion formed at a first end portion of the fixation portion, and
a second fixation portion formed at a second end portion of the fixation portion, and
the fixing target portion includes
a first fixing target portion that is fixed to the first fixation portion, and
a second fixing target portion that is fixed to the second fixation portion.

12. The lens device according to claim 1,
wherein a fixing structure for fixation of the fixation frame and the switch portion is a fitting structure.

13. The lens device according to claim 1,
wherein the fitting portion is formed at an inner peripheral surface of the fixation frame.

14. The lens device according to claim 1,
wherein the fitting portion is not exposed at an outer peripheral surface of the fixation frame.

15. The lens device according to claim 1,
wherein a direction along a direction intersecting an optical axis is set as a direction in which the fitting target portion is fitted to the fitting portion.

16. The lens device according to claim 1,
wherein the fitting portion is formed in a recessed shape.

17. The lens device according to claim 1,
wherein the fitting portion includes a locking portion, and
the fitting target portion includes a locking target portion that is engaged with the locking portion in a direction along an optical axis.

18. The lens device according to claim 1,
wherein the elastic portion extends in a direction along a direction intersecting an optical axis.

19. The lens device according to claim 1,
wherein the fitting target portion includes a slit formed along the elastic portion.

20. The lens device according to claim 19,
wherein the switch portion includes a slide switch as a switch related to an operation performed on a lens,
a direction along an optical axis is set as a direction in which the slide switch is operated, and
the slit extends in a direction along a direction intersecting the optical axis.

21. The lens device according to claim 1,
wherein the contact portion has a shape that elastically deforms the elastic portion in a direction in which the switch portion is pulled toward an inside of the fixation frame.

22. The lens device according to claim 1,
wherein the contact portion is formed in a protruding shape.

23. The lens device according to claim 1,
wherein the fitting target portion includes a plurality of hooked portions that are hooked onto the fitting portion, and
the plurality of hooked portions include
a first hooked portion that is adjacent to the elastic portion on a first side in a direction along an optical axis, and
a second hooked portion that is adjacent to the elastic portion on a second side in the direction along the optical axis.

24. A manufacturing method of a lens device, the method comprising:
a fixing step of fixing a switch portion to a fixation frame by means of a fixing member,
wherein the fixing step includes a fitting step of fitting a fitting target portion of the fixing member to a fitting portion of the fixation frame, and
the fitting step includes bringing an elastic portion of the fitting target portion into contact with a contact portion of the fitting portion so that the elastic portion is elastically deformed.
